(19) United States
(12) Patent Application Publication
(10) Pub. No.: US 2011/0038977 A1
(43) Pub. Date: Feb. 17, 2011

(54) Vertical Molding Machine

(76) Inventors: Yong Zheng, Taipei Hsien (TW); Riguang Cheng, Tu-Cheng City (TW); Lu Yang Chen, Tu-Cheng City (TW)

Correspondence Address: Lin & Associates;Intellectual Property, Inc., PO Box 2339, Saratoga, CA, 95070-0339, US

(21) Appl. No.: 12/540,371

(22) Filed: Aug. 13, 2009

(51) Int. Cl. B29C 33/72

(52) U.S. Cl. 425/225

(57) ABSTRACT

A vertical molding machine has an upper mold, a lower mold matched with the upper mold to define a molding cavity therebetween and at least one cleaning device having a base body mounted to a side of the upper mold. A top surface of the lower mold is acted as a mating surface. The base body defines a passageway with one end opened freely for receiving external gas. The base body further defines at least one blowhole. One end of the blowhole is connected with the passageway and the other end thereof penetrates through the base body to be exposed towards the mating surface of the lower mold so as to make the external gas flown onto the mating surface of the lower mold blow through the passageway and the blowholes.

### BACKGROUND OF THE INVENTION

1. Field of the Invention

The present invention generally relates to a vertical molding machine, and more particularly to a vertical molding machine having a cleaning function.

2. The Related Art

A conventional vertical molding machine includes an upper mold and a lower mold matched with the upper mold to define a molding cavity therebetween for injection molding a product therein. However, some sundries, dusts and scraps may fall on the lower mold when the vertical molding machine is opened so that affects the quality of the products and may make the vertical molding machine damaged. Therefore, a vertical molding machine capable of overcoming the foregoing problems is required.

### SUMMARY OF THE INVENTION

An object of the present invention is to provide a vertical molding machine having a cleaning function. The vertical molding machine has an upper mold, a lower mold matched with the upper mold to define a molding cavity therebetween and at least one cleaning device having a base body mounted to a side of the upper mold. A top surface of the lower mold is acted as a mating surface. The base body defines a passageway with one end opened freely for receiving external gas. The base body further defines at least one blowhole. One end of the blowhole is connected with the passageway and the other end thereof penetrates through the base body to be exposed towards the mating surface of the lower mold so as to make the external gas flown onto the mating surface of the lower mold blow through the passageway and the blowholes during the vertical molding machine being closed.

As described above, the vertical molding machine of the present invention utilizes the cleaning device to make the external gas blow to the mating surface of the lower mold during the vertical molding machine being closed so as to keep the mating surface of the lower mold clean. This assures the quality of a product mold in the molding cavity and lengthens the using life of the vertical molding machine.

### BRIEF DESCRIPTION OF THE DRAWINGS

The present invention will be apparent to those skilled in the art by reading the following description, with reference to the attached drawings, in which:

FIG. 1 is a perspective view of a vertical molding machine in accordance with the present invention, wherein the vertical molding machine is closed;

FIG. 2 is a perspective view of the vertical molding machine of FIG. 1 showing a partially sectional view of a base body, wherein the vertical molding machine is opened;

FIG. 3 is an exploded view of the vertical molding machine of FIG. 2; and

FIG. 4 is a perspective view of a lower mold of the vertical molding machine of FIG. 1.

### DETAILED DESCRIPTION OF THE PREFERRED EMBODIMENT

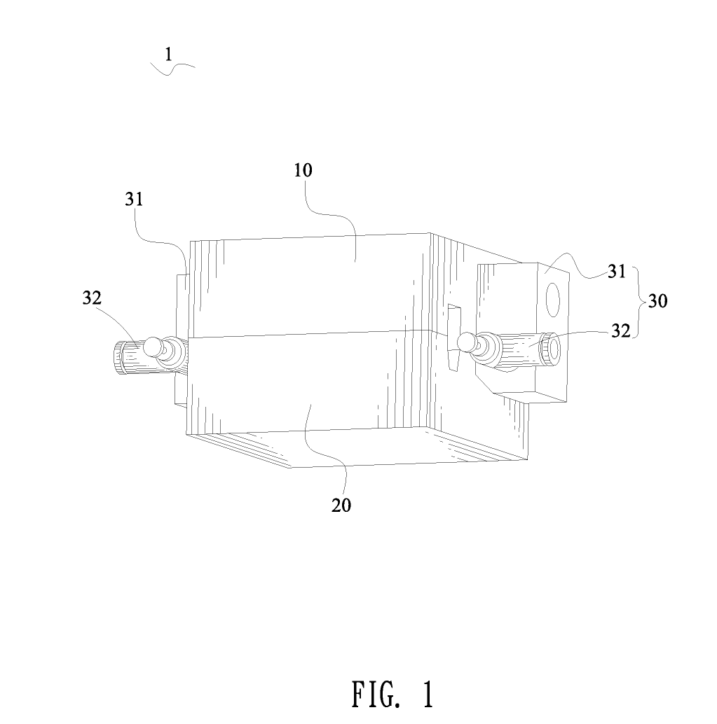

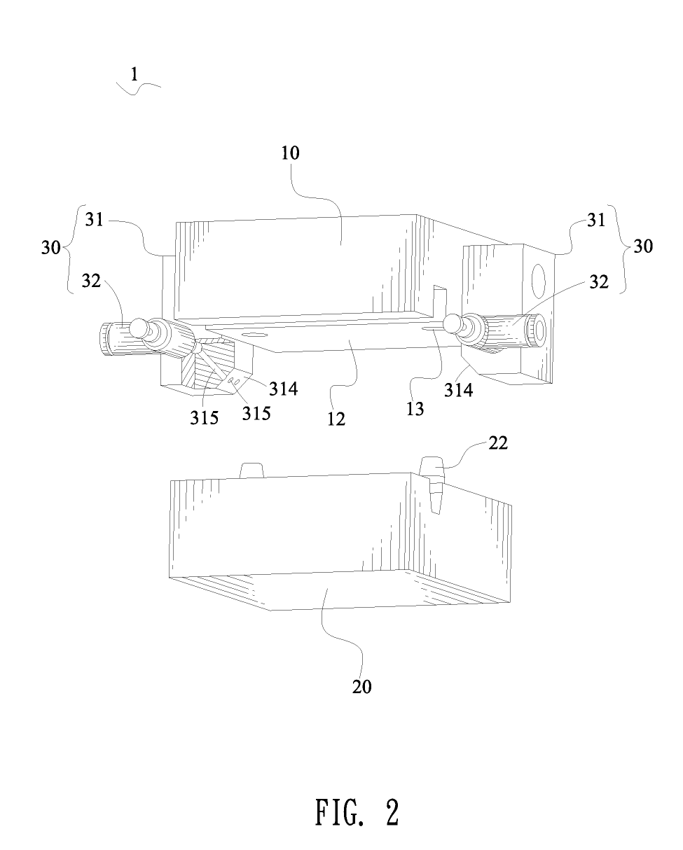

Referring to FIG. 1 and FIG. 2, a vertical molding machine 1 includes an upper mold 10, a lower mold 20 and a pair of cleaning devices 30 mounted to two opposite sides of the upper mold 10.

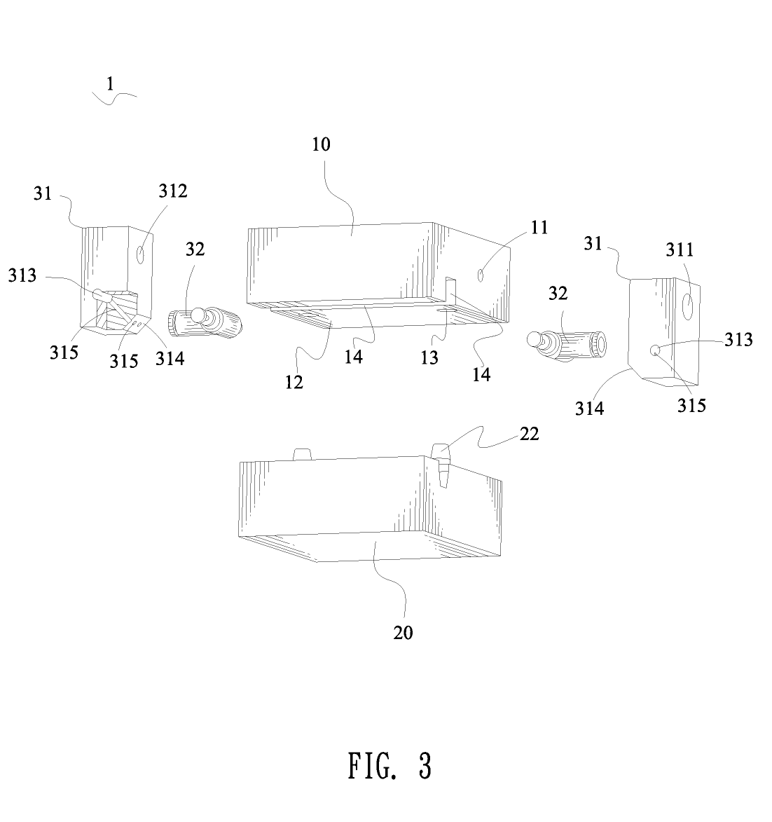

Referring to FIG. 3, the upper mold 10 is of substantially rectangular shape. The two opposite sides of the upper mold 10 respectively define a locating aperture 11 with cylindrical shape extending transversely. A bottom surface of the upper mold 10 is acted as a first mating surface 12. The first mating surface 12 of the upper mold 10 defines a pair of positioning holes 13 transversely spaced from each other. The first mating surface 12 further defines a first molding cavity 14 located in front of the positioning holes 13 and extending transversely to pass through the two opposite sides of the upper mold 10.

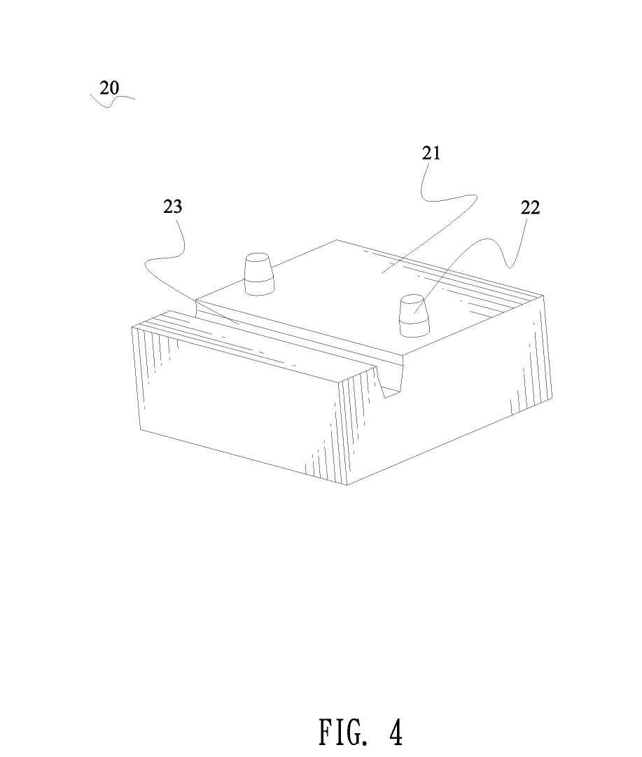

Referring to FIG. 2 and FIG. 4, the lower mold 20 is of substantially rectangular shape and matching with the upper mold 10. A top surface of the lower mold 20 is acted as a second mating surface 21. The second mating surface 21 of the lower mold 20 protrudes upward to form a pair of cone positioning portions 22 transversely spaced from each other and corresponding to the positioning holes 13. The second mating surface 21 further defines a second molding cavity 23 located in front of the positioning portions 22 and extending transversely to pass through two opposite sides of the lower mold 20.

Referring to FIG. 2 and FIG. 3 again, each of the cleaning devices 30 includes a rectangular base body 31 and a control valve 32. An upper portion of the base body 31 defines a fixing groove 311 and a connecting groove 312 each extending transversely. One end of the connecting groove 312 is connected with a middle of one end of the fixing groove 311, and the other ends of the fixing groove 311 and the connecting groove 312 oppositely penetrate through two opposite side surfaces of the base body 31. A lower portion of the base body 31 defines a passageway 313 extending longitudinally to pass through a front surface thereof. A slope 314 is formed at a lower corner of the base body 31 to smoothly connect a bottom surface and one corresponding side surface of the base body 11, wherein the corresponding side surface is the one penetrated through by the connecting groove 312. A plurality of blowholes 315 are formed between the passageway 313 and the slope 314. One end of each of the blowholes 315 is connected with the passageway 313 and the other end thereof penetrates through the slope 314. Each of the blowholes 315 is inclined downward from the passageway 313 to the slope 314.

Referring to FIGS. 1-4 again, in assembly, one end of the control valve 32 is fastened in the passageway 313 of the base body 31 and the other end of the control valve 32 is connected with a windpipe (not shown) for controlling run-off of gas which passes through the control valve 32 from the windpipe to the base body 31. The two cleaning devices 30 are mounted to the two opposite sides of the upper mold 10 by means of a fixing bar (not shown) with a middle received in the corresponding connecting groove 312, one end fixed in the corresponding fixing groove 311 of the base body 31 and the other end fixed in the corresponding locating aperture 11 of the upper mold 10 for forming a firm engagement between the upper mold 10 and the base body 31. The lower portion of each of the base bodies 31 projects beyond the first mating surface 12 of the upper mold 10 to make the slope 314 exposed so as to make the blowholes 315 face the second mating surface 21 of the lower mold 20 before the vertical molding machine 1 is closed.

In use, the upper mold 10 moves downward to approach the lower mold 20 for making the vertical molding machine 1 closed. In the process of the vertical molding machine 1 being closed, the gas is blown from the windpipe to successively pass through the control valve 32, the passageway 313 and the blowholes 315, and then blown onto the second mating surface 21 of the lower mold 20 for blowing sundries, dusts and scraps on the second mating surface 21 away. When the upper mold 10 is about to match with the lower mold 20, the control valve 32 is controlled to break off the gas. Then the vertical molding machine 1 is fully closed and a molding cavity is formed by the first molding cavity 14 of the upper mold 10 and the second molding cavity 23 of the lower mold 20 matched with each other for injection molding a product (not shown) therein. Furthermore, the positioning portions 22 of the lower mold 20 are positioned in the corresponding positioning holes 13 of the upper mold 10 to ensure a firm engagement between the lower mold 20 and the upper mold 10 when the vertical molding machine 1 is closed.

As described above, the vertical molding machine 1 of the present invention utilizes the cleaning device 30 to make the gas blown to the second mating surface 21 of the lower mold 20 during the vertical molding machine 1 being closed so as to blow the sundries, dusts and scraps on the second mating surface 21 away for keeping the second mating surface 21 of the lower mold 20 clean. This promotes the quality of the product mold in the molding cavity and product life of the vertical molding machine 1.

The forgoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A vertical molding machine, comprising:
an upper mold;
a lower mold matched with the upper mold to define a molding cavity therebetween, a top surface of the lower mold being acted as a mating surface; and
at least one cleaning device having a base body mounted to a side of the upper mold, the base body defining a passageway with one end opened freely for receiving external gas, the base body further defining at least one blowhole, one end of the blowhole being connected with the passageway and the other end thereof penetrating through the base body to be exposed towards the mating surface of the lower mold so as to make the external gas flown onto the mating surface of the lower mold blow through the passageway and the blowholes during the vertical molding machine being closed.

2. The vertical molding machine as claimed in claim 1, wherein the blowhole extends at an acute angle with respect to the mating surface of the lower mold, the blowhole penetrating through a lower corner towards the mating surface of the lower mold.

3. The vertical molding machine as claimed in claim 2, wherein a slope is formed at the lower corner of the base body to connect the bottom surface and the side surface against the upper mold, the base body is mounted to make the slope exposed beyond a bottom surface of the upper mold, the bottom end of each of the blowholes penetrates through the slope.

4. The vertical molding machine as claimed in claim 1, wherein the cleaning device further includes a control valve connected with the passageway of the base body for controlling run-off of the external gas which passes through the control valve to the base body of the cleaning device.

5. The vertical molding machine as claimed in claim 1, wherein a locating aperture is formed at the side of the upper mold, the base body further defines a fixing groove and a connecting groove, one end of the connecting groove is connected with a middle of one end of the fixing groove, and the other ends of the fixing groove and the connecting groove oppositely penetrate through two opposite side surfaces of the base body, the upper mold and the base body are assembled with each other by means of the locating aperture, the connecting groove and the fixing groove.

6. The vertical molding machine as claimed in claim 1, wherein the mating surface of the lower mold protrudes upward to form a pair of positioning portions spaced from each other, the bottom surface of the upper mold defines a pair of positioning holes, the positioning portions are fastened in the corresponding positioning holes to form a firm engagement between the lower mold and the upper mold when the vertical molding machine is fully closed.

7. The vertical molding machine as claimed in claim 6, wherein each of the positioning portions is of cone shape.
